(19) United States
(12) Patent Application Publication
(10) Pub. No.: US 2003/0020670 A1
(43) Pub. Date: Jan. 30, 2003

(54) Helical antenna

(75) Inventor: Junichi Noro, Akita-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Mitsumi Electric Co. Ltd., Tokyo (JP)

(21) Appl. No.: 10/202,717

(22) Filed: Jul. 25, 2002

(30) Foreign Application Priority Data
Jul. 26, 2001 (JP) 225515/2001
Sep. 10, 2001 (JP) 273042/2001

(51) Int. Cl. H01Q 1/36

(52) U.S. Cl. 343/895

(57) ABSTRACT

In a helical antenna having an antenna pattern of a helical shape, the antenna pattern extends along a cylindrical body formed by an insulating film member which is rolled into a cylindrical shape. A circuit board is placed opposite to one of axial ends of the cylindrical body. The circuit board is formed with a circuit pattern connected to the antenna pattern by soldering. The cylindrical body has a specific part which is not provided with the antenna pattern and is fixed to the circuit board.

### BACKGROUND OF THE INVENTION

This invention relates to a helical antenna which can be used in a digital radio receiver and the like.

In recent years, a digital radio receiver for receiving a radio wave from an artificial satellite (which may be called a “satellite wave” hereinafter) or a radio wave from a ground station (which may be called a “ground wave” hereinafter) to listen to digital radio broadcasting has been developed and is about to be put into practical use. The digital radio receiver is mounted on a mobile station such as a vehicle and is adapted to receive a radio wave having a frequency of about 2.3 GHz to listen to the digital radio broadcasting. In other words, the digital radio receiver is a radio receiver capable of listening to mobile broadcasting. It is noted here that the ground wave is a radio wave obtained by slightly shifting the frequency of the satellite wave after it is received by the ground station.

In order to receive the radio wave having the frequency of about 2.3 GHz, it is necessary to mount an antenna at a position outside a vehicle. Such antenna may have various structures, but a stick type is generally used rather than a planar type (or a flat type).

As well known, an electromagnetic wave emitted into a free space is a transversal wave having an electric field and a magnetic field vibrating in a plane perpendicular to a propagating direction of the wave. The electric field and the magnetic field are variable in intensity within the above-mentioned plane. Such electromagnetic wave in which the direction of the electric field is not random but constant or varied in some regular way is referred to as a polarized wave. The satellite wave is a circular polarized wave exhibiting circular polarization while the ground wave is a linear polarized wave exhibiting linear polarization.

As one of stick-type antennas, a helical antenna is known. The helical antenna comprises a hollow or solid cylindrical body and a conductor wire wound around the cylindrical body in a helical shape (or a spiral shape) and can efficiently receive the above-mentioned circular polarized wave. Therefore, the helical antenna is exclusively or mainly used to receive the satellite wave.

It is unavoidable or inevitable for an automobile to vibrate when moving. Therefore, the helical antenna to be mounted on the automobile must be provided with a sufficient anti-vibration measure. It is needless to say that the helical antenna is required to be excellent in durability.

### SUMMARY OF THE INVENTION

It is therefore an object of this invention to provide a helical antenna which is excellent in vibration resistance and which is improved in durability.

It is another object of this invention to provide a helical antenna which is improved in workability in an assembling operation.

Other objects of the present invention will become clear as the description proceeds.

According to the present invention, there is provided a helical antenna which comprises

a cylindrical body formed by an insulating film member which is rolled into a cylindrical shape, an antenna pattern extending in a helical shape along said cylindrical body, a circuit board opposite to one of axial ends of the cylindrical body, a circuit pattern formed on the circuit board; a connecting portion connecting the antenna pattern with the circuit pattern by soldering, and a fixed portion fixing the circuit board to a specific part of the cylindrical body, the specific part being not provided with the antenna pattern.

### BRIEF DESCRIPTION OF THE DRAWING

FIG. 1 is a front view of a helical antenna according to a first embodiment of this invention;

FIG. 2 is a plan view of the helical antenna shown in FIG. 1;

FIG. 3 is a developed view of an antenna element used in the helical antenna shown in FIGS. 1 and 2;

FIG. 4 is a plan view of a circuit board used in the helical antenna shown in FIGS. 1 and 2;

FIG. 5 is a front view for describing an assembling operation of a helical antenna according to a second embodiment of this invention;

FIG. 6 is a developed view of an antenna element used in the helical antenna shown in FIG. 5; and

FIG. 7 is a plan view of a circuit board for use in the helical antenna shown in FIG. 5.

### DESCRIPTION OF THE PREFERRED EMBODIMENTS

With reference to FIGS. 1 to 4, description will be made about a helical antenna according to a first embodiment of the present invention.

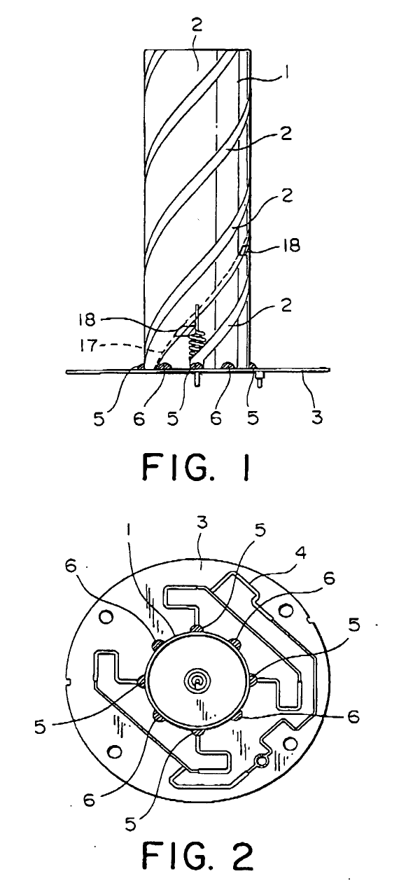

The helical antenna shown in FIGS. 1 and 2 comprises a cylindrical body 1 formed by a flexible insulating film member rolled into a cylindrical shape and fixed to keep the cylindrical shape, four antenna patterns 2 each of which comprises a conductor and is formed on the cylindrical body 1 to extend in a helical fashion or shape along its peripheral surface, a circuit board 3 fixed to one of axial ends of the cylindrical body 1, a circuit pattern 4, such as a phase-shift circuit, formed on the circuit board 3, and four connecting portions 5 through which the antenna patterns 2 are electrically and mechanically connected to the circuit pattern 4 by soldering, respectively.

Between every adjacent ones of the four connecting portions 5, four fixing portions 6 are arranged through which the cylindrical body 1 is fixed to the circuit board 3. In other words, each fixed portion 6 fixes each of specific parts of the cylindrical body 1 different from those parts provided with the antenna patterns 2 to the circuit board 3.

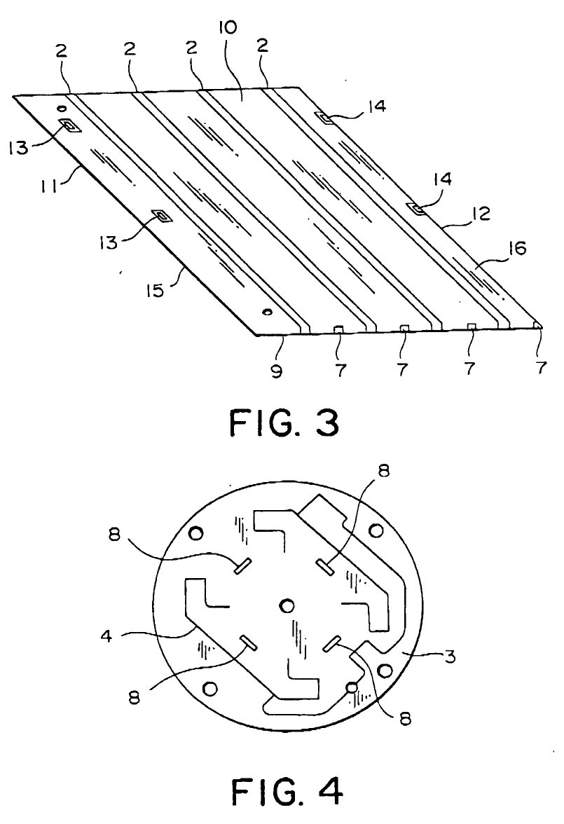

With reference to FIGS. 3 and 4, the description will be proceeded further.

Each of the fixed portions 6 comprises a metal member 7 formed at the above-mentioned specific part of the cylindrical body 1 and another metal member 8 formed on the circuit board 3 and connected to the metal member 7 by soldering. Consequently, the cylindrical body 1 is fixed to the circuit board 3 at eight positions in total by the four connecting portions 5 and the fixed portions 6 interposed between the connecting portions 5. Thus, the helical antenna mentioned above is excellent in vibration resistance and improved in durability.

The cylindrical body 1 is formed by an insulating film member 10 shown in FIG. 3. The insulating film member 10 has a substantially parallelepiped shape. The insulating film member 10 has one surface provided with four antenna patterns 2 which are formed by etching or the like to extend in parallel to one another with a space kept from one another. Each antenna pattern 2 extends substantially obliquely from a specific side 9 of the insulating film member 10.

The insulating film member 10 has a pair of oblique sides 11 and 12 which are inclined with respect to the specific side 9 and extend in parallel to the antenna patterns 2. In the vicinity of the oblique sides 11 and 12, fixing patterns 13 and 14 made of metal are formed, respectively. These fixing patterns 13 and 14 may be produced simultaneously with and in the manner similar to the antenna patterns 2.

The insulating film member 10 is rolled into the cylindrical shape around a center axis perpendicular to the specific side 9. The insulating film member 10 has opposite end portions 15 and 16 in a circumferential direction. The opposite end portions 15 and 16 are connected to each other to thereby form a film connecting portion. In the film connecting portion, the opposite end portions 15 and 16 of the insulating film member 10 are overlapped with each other to form an overlapping portion. A double-sided adhesive tape 17 is inserted in the overlapping portion to thereby adhere the opposite end portions 15 and 16 to each other. Furthermore, opposite ones of the fixing patterns 13 and 14 are soldered to each other to thereby form a solder connecting portion 18. In this manner, the cylindrical shape of the cylindrical body 1 is fixed and maintained.

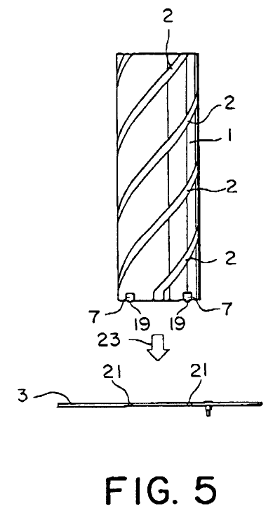

With reference to FIGS. 5 to 7, the description will be made about a helical antenna according to a second embodiment of the present invention. Similar parts are designated by like reference numerals and will not be described any longer.

In FIG. 5, four antenna patterns 2 each comprising a conductor are formed on a cylindrical body 1 to extend in a helical fashion along its peripheral surface. At the one axial end of the cylindrical body 1, a plurality of metal protrusions, that is, positioning tabs 19 are formed at four positions spaced from one another in a circumferential direction of the cylindrical body. Each of the positioning tabs 19 is formed integral with metal members 7 formed on the above-mentioned specific parts of the cylindrical body 1. On the other hand, a circuit board 3 is provided with engaging holes 21 to be engaged with the positioning tabs 19, respectively.

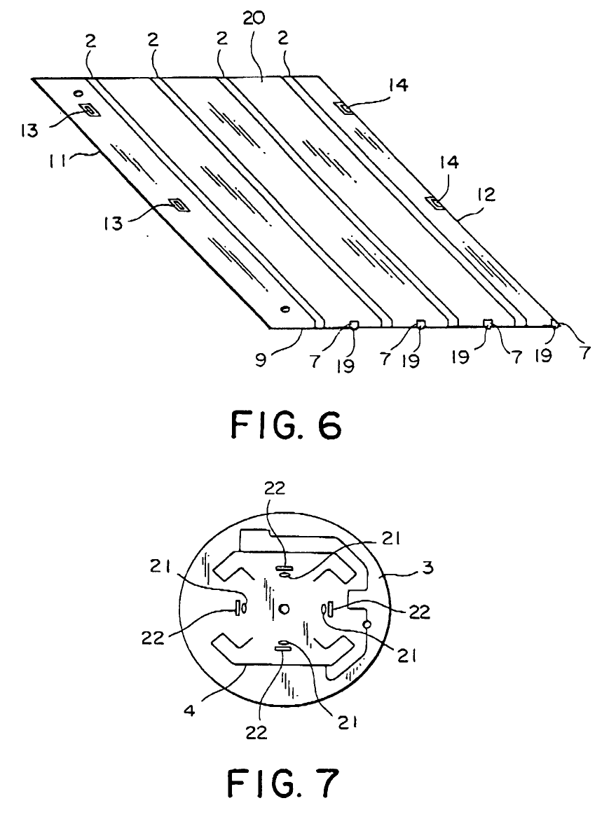

The cylindrical body 1 is formed by an insulating film member 20 shown in FIG. 6. The insulating film member 20 also has a substantially parallelepiped shape. The insulating film member 20 has one surface provided with the four antenna patterns 2 which are formed by etching or the like to be in parallel to one another with a space kept from one another. Each antenna pattern 2 substantially obliquely extends from a specific side 9 of the insulating film member 20. The metal members 7 and the positioning tabs 19 integral therewith are provided at four positions on the specific side 9 of the film member 20.

The film member 20 is provided with fixing patterns 13 and 14 made of metal and formed in the vicinity of a pair of oblique sides 11 and 12 which are inclined with respect to the specific side 9 and extend in parallel to the antenna patterns 2. The fixing patterns 13 and 14 and the positioning tabs 19 may be produced simultaneously with and in the manner similar to the antenna patterns 2.

Thereafter, the film member 20 is rolled into a cylindrical shape around a center axis perpendicular to the specific side 9. opposite one of the fixing patterns 13 and 14 are soldered to each other to thereby fix the cylindrical shape of the cylindrical body 1. In order to fix the cylindrical shape of the cylindrical body 1, a double-sided adhesive tape may be additionally used in the manner similar to the helical antenna shown in FIGS. 1 and 2.

With reference to FIG. 7 in addition, the description will be made about the circuit board 3.

The circuit board 3 is a phase shifter substrate having a circuit pattern 4 to serve as a phase-shift circuit. On the circuit board 3, the engaging holes 21 are formed at positions corresponding to the positioning tabs 19 of the cylindrical body 1. The engaging holes 21 are formed into a shape and a size adapted to receive the positioning tabs 19. In the vicinity of each engaging hole 21, a rectangular ground pattern 22 is fixed. The ground pattern 22 is provided with a through hole and connected via the through hole to a ground plane formed on a back surface of the phase shifter substrate. By forming the through hole in the ground pattern 22, it is possible to prevent the ground pattern 22 from being detached.

As depicted by an arrow 23 in FIG. 5, when the cylindrical body 1 is mounted on the circuit board 3, the positioning tabs 19 of the cylindrical body 1 are inserted into the engaging holes 16 of the circuit board 3 to be engaged with edge portions of the engaging holes 16. As a result, the cylindrical body 1 is temporarily fastened to the circuit board 3. Specifically, the cylindrical body 1 is locked or inhibited with respect to rotation around its cylindrical axis as well as movement along the circuit board 3.

In the state where the cylindrical body 1 is temporarily fastened, at least one of the metal member 7 and the positioning tab 19 is soldered to the ground pattern 22 so that the cylindrical body 1 is mechanically connected to the circuit board 3. Simultaneously or approximately simultaneously, the antenna patterns 2 are soldered and electrically connected to a circuit pattern 4 in the manner similar to that explained in conjunction with FIGS. 1 and 2. Thus, the cylindrical body 1 is mounted on the circuit board 3 in a predetermined state. In the mounting operation, the cylindrical body 1 is temporarily fastened to the circuit board 3. It is therefore easy to perform the soldering operation. In addition, it is possible to avoid deterioration in performance due to positioning error.

What is claimed is:

1. A helical antenna comprising:
a cylindrical body formed by an insulating film member which is rolled into a cylindrical shape;
an antenna pattern extending in a helical shape along said cylindrical body;
a circuit board opposite to one of axial ends of said cylindrical body;
a circuit pattern formed on said circuit board;
a connecting portion connecting said antenna pattern with said circuit pattern by soldering; and
a fixed portion fixing said circuit board to a specific part of said cylindrical body, said specific part being not provided with said antenna pattern.

2. A helical antenna according to claim 1, wherein said fixed portion comprises:
a metal member formed on said specific part;
another metal member formed on said circuit board; and
a soldering portion connecting both of said metal members.

3. A helical antenna according to claim 1, wherein said cylindrical body has a film connecting portion connecting opposite end portions of said insulating film member in its circumferential direction to each other.

4. A helical antenna according to claim 3, wherein said film connecting portion comprises:
an overlapping portion formed by overlapping said opposite end portions of said insulating film member with each other; and
a double-sided adhesive tape inserted in said overlapping portion to thereby adhere said opposite end portions to each other.

5. A helical antenna according to claim 3, wherein, in said film connecting portion, said opposite end portions of said insulating film member or adjacent portions thereof are connected by soldering.

6. A helical antenna according to claim 1, wherein said insulating film member has a specific side faced to said circuit board, said antenna pattern extending obliquely from said specific side.

7. A helical antenna according to claim 6, wherein said insulating film member has a substantially parallelepiped shape with a pair of oblique sides which are inclined with respect to said specific side and extend in parallel to said antenna pattern.

8. A helical antenna according to claim 7, wherein said insulating film member has a pair of end portions in the vicinity of said pair of oblique sides, respectively, said insulating film member being rolled into a cylindrical shape with said end portions connected to each other so that the cylindrical shape is fixed and maintained.

9. A helical antenna according to claim 8, wherein said end portions are provided with fixing patterns made of metal, respectively, said fixing patterns being faced to each other and connected by soldering a condition where said insulating film member is rolled into the cylindrical shape.

10. A helical antenna according to claim 9, wherein said end portions are faced to each other in a radial direction of said cylindrical body and adhered to each other by a double-sided adhesive tape.

11. A helical antenna according to claim 1, wherein said cylindrical body has a positioning tab at said one of the axial ends thereof, said circuit board having an engaging hole, said cylindrical body being temporarily fastened to said circuit board by engagement of said positioning tab and said engaging hole.

12. A helical antenna according to claim 11, wherein said positioning tab is a protrusion made of metal and fixedly attached to said insulating film member.

13. A helical antenna according to claim 1, wherein said circuit board is a phase shifter substrate comprising a phase-shift circuit.
